(19) United States
(12) Patent Application Publication
(10) Pub. No.: US 2014/0130503 A1
(43) Pub. Date: May 15, 2014

(54) TURBOFAN ENGINE WITH CONVERGENT - DIVERGENT EXHAUST NOZZLE

(71) Applicant: Cor Leep, Arnhem (NL)

(72) Inventor: Cor Leep, Arnhem (NL)

(21) Appl. No.: 14/131,802

(22) PCT Filed: Jul. 13, 2012
(86) PCT No.: PCT/NL2012/000049

§ 371 Date: Jan. 9, 2014

(30) Foreign Application Priority Data
Jul. 15, 2011 (NL) 2007124
Jul. 13, 2012 (WO) NL2012/000049

(51) Int. Cl. F02K 1/28

(52) U.S. Cl. CPC F02K 1/28
USPC 60/770

(57) ABSTRACT

With the speedy and hot airplane turbojet exhaust gases a lot of energy is blown away and wasted nowadays. By this invention a venturi (35) and a diverging duct (14) transform this exhaust energy into a useful and strong low pressure gas stream that sucks outside air through a fan (3) and a bypass (9,10,11) outside the original turbojet engine. (here called core engine). Thus the fan (3) is propelled and drives the central shaft (2) of the core engine (4). Now the turbine (7) in the rear of the core engine (4) can deliver less energy to the central shaft (21) for maintaining the right rotation. Likewise turbine (7) can absorb less energy out of the hot and speedy gases inside the core engine. A bigger part of this energy is available for creating thrust now. That is the major profit of this new invention.

The invention relates to an improved jet engine for air planes. It also relates to air planes comprising such an improved jet engine.

Nowadays turbojets in their basic principle consist of an air inlet, an air compressor, a combustion chamber, a gas turbine (that drives the air compressor etc.) and a nozzle. The air is compressed into the chamber, heated and expanded by the fuel combustion and then allowed to expand out through the turbine into the nozzle where it is accelerated to high speed to enable propulsion. Turbojets are quite inefficient if flown below about Mach 2, and very noisy.

Most modern aircraft use turbofan jet engines instead for economic reasons. A turbofan is a type of aircraft jet engine based around a turbojet engine. A turbofan provides thrust using a combination of a ducted fan and a jet exhaust nozzle. Part of the inlet airstream from the ducted fan passes through the core inlet, providing oxygen to burn fuel to create power. However, the rest of the air flow bypasses the engine core and mixes with the faster stream from the core, significantly reducing exhaust noise. The combination of substantially slower bypass airflow plus the high speed air from the core produces thrust more efficiently than the high-speed air from the core alone, and this reduces the specific fuel consumption. Because turbofans have a net exhaust speed that is much lower than a turbojet, they are much more efficient at subsonic speeds than turbojets, and somewhat more efficient at supersonic speeds up to roughly Mach 1.6. They are also more efficient when used with continuous afterburner at Mach 3 and above. However, the lower exhaust speed may also reduce thrust at high speeds.

Publication EP 0426500 A1 describes a turbo fan jet engine driven from an LP turbine through a hollow overhung rearward extending drive shaft. The fan, turbine and shaft are co-axial. The core engine exhausts through the centre around the shaft and through a primary nozzle. Downstream of the primary nozzle the hot turbine exhaust mixes with cooler bypass air. The mixed flow finally exits through a convergent/divergent final nozzle. In the case of EP 0426500 A1 and in other known jet engines, the fan is driven by the turbine.

It is the object of the present invention to provide a jet propulsion system which has reduced fuel consumption as compared the jet engines of the state of the art mentioned above.

This object is achieved by an airplane jet engine comprising:
an air inlet capable of receiving air;
a fan, located at the air inlet, through which the entire amount of air received from the air inlet passes;
a core engine for generating a thrust, said engine being located downstream from the fan.

The core engine comprises:
a compressor section arranged to compress the air received from a central part of the air inlet,
a combustion section arranged to combust fuel and the compressed air, to generate combusted hot gases,
a turbine to be driven by said combusted gases, said turbine being connected to said fan via a rotation axis, and
a core engine outlet, where the combustion gases leave the core engine. The jet engine further comprises:
at least one bypass duct through which air is bypassed with regard to and outside the core engine, the bypass duct having a bypass inlet directly downstream the fan and a bypass outlet, where the bypassed air leaves the bypass duct;
a venturi comprising a convergent-divergent nozzle with a throat at the minimum cross-sectional area of the nozzle, wherein the exhaust gases from the core engine are sucking bypass air through the bypass duct, so that both streams of gases are ejected into the throat of the venturi when the engine is operational. The throat is positioned downstream the site where the combustion gases that leave the core engine, and bypass air that leaves the bypass duct, initially meet, when the engine is operational. The throat is positioned downstream the site where the combustion gases that leave the core engine, and bypass air that leaves the bypass duct, initially meet, when the engine is operational, and wherein downstream said throat of the convergent-divergent nozzle of the venturi a divergent exhaust part is arranged, leading the mix of gases to the outside. An inner wall of the exhaust part makes an angle α with the main axis of the engine which angle α has a value between 10 and 25 degrees.

Due to the proportion of the throat relative to the core engine outlet, the mixture of the two streams of gases create, at least in use, an under pressure at the outlet of the bypass duct relative to the air in front of the fan in two cooperating ways; by the venturi and by de diverging duct as explained in the following.

In the widening duct, also referred to as exhaust part, the inner wall makes an angle α with the main axis of the jet engine with a value of more than 10 degrees but less than 25 degrees. The advantage of this relatively small angle choice is that the stream of gases will stay profoundly in touch with this inner wall. The exact value of the angle depends on the properties and size of the core engine and on the properties of the gas mixture, as will be appreciated by the skilled person. For example, in a sailing boat in clean air the sails are orientated so as to keep a contact on maximum 11 degrees of the wind, which mostly determined in an empirical way.

In the invention, the venturi principle is applied such as known in burners for the combustion of gas in industry and housekeeping. The here announced version of the convergent-divergent nozzle is partly based on that principle.

Generally it has been built up out of a central high speed gas flow that is sucking additional surrounding gases or air with lower speed through the throat of the venturi.

In the present solution the central high speed gas flow is the outlet of the central engine and the additional added gases approach through the bypass duct. The mix of both quantities of gases pass the throat of the convergent/divergent nozzle as well as the same throat of the venturi and change out their different speeds and temperatures into one average speed and one average temperature.

The divergent exhaust part, i.e. duct, receives the entire quantity of mixed gases and leads them to the outside. By widening of this duct from the said throat to the outside, the surface of the cross section increases and in this way the speed of the gases decreases. Thus a change of pressure occurs between inlet and outlet of the diverging duct as a consequence of the slowing down of the gases, Bernoulli Effect.

Also the cooling down of the exhaust gases of the core engine by being mixed up with cold outside air decreases the volume of the hot gases and also decreases the speed of the exhaust gases.

In our solution higher pressure occurs at the end of the diverging duct where the speed is lowest and where the outlet is located. There the gases meet outside air and equalize their pressure to atmospheric outside pressure.

The minimum pressure occurs directly downstream the throat of the nozzle, where the speed is higher than elsewhere in the diverging duct; exactly where that low pressure is needed for being transported through the bypass to the front of the core engine.

This under pressure will suck outside approaching air and increase the air flow through the bypass. When there would be no fan in the inlet of the bypass the sucking of outside air would also cause an extra quantity of thrust. In this case we prefer for the big liners a fan in the front of the bypass to which the entering air and the under pressure will contribute to the rotation of the fan and the central shaft. This means that the fan receives energy from the under pressure and the thus caused strong stream of air through the bypass duct.

Please note that this is contrary to the state of the art turbofan bypass jet engines in which the fan causes a flow through the bypass duct.

Because of this contribution mentioned, the turbine in the rear of the core engine does not have to generate so much rotating power and needs less energy out of the hot and speedy gases to create the same rotational speed for the central shaft and so for the compressor and eventual other energy users such as an electric generator and a blower for air refreshing for passengers and crew.

By the choice of the relationship between the diameter of the throat and the diameter of the core engine outlet a relationship between the quantity of sucked outside air and available outlet gases of the core engine can be influenced. In our prototype a factor 2 worked very satisfying. Also this relationship can definitively be decided when design has seen daylight.

For generating the low pressure, the speed and heat out of the exhaust gases are used, which were almost fully wasted up till now. No decrease of performance of the core engine occurs. On the contrary: the low pressure downstream the outlet of the core engine will stimulate the performance of the core engine a little bit instead of disturbing it. Besides that a lower speed of the exhaust gases (for example from 1.800 Km/h to 900 Km/h causes less noise pollution.

According to an embodiment, the fan is a tandem fan comprising a first set of blades in an inner part of the fan, and a second set of blades in an outer part of the fan, said blades of said first set having a different pitch from the blades of the second set. Using different pitches enables the designer to optimize the relative flow through the bypass as compared to the flow through the engine.

In a further embodiment, the jet engine comprises one or more additional bypasses and valves, so that an adjustable part of the hot gases can be conducted around the turbine in the rear of the core engine adjustable to different running circumstances.

The invention also relates to an airplane comprising one or more jet engines as described above.

Further details and advantages of the present invention will become clear to the reader after reading the description of the embodiments described below with reference to the accompanying drawings, in which:

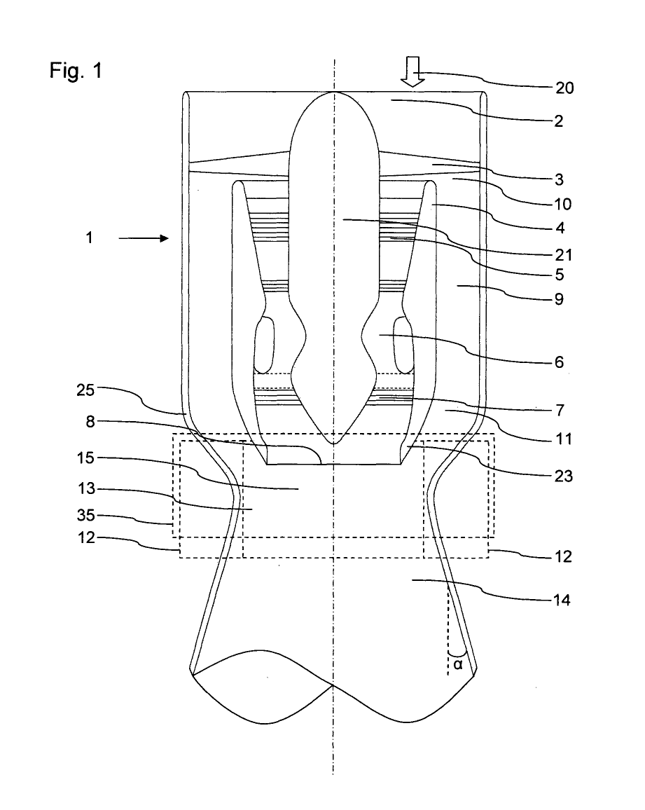

FIG. 1 shows a schematic cross section of a jet engine according to an embodiment of the invention;

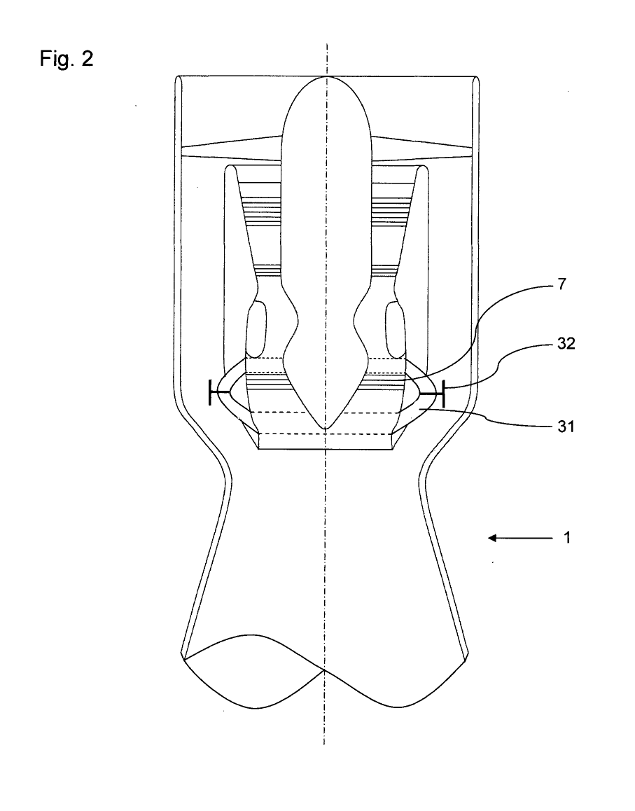

FIG. 2 shows a schematic cross section of a jet engine according to a further embodiment of the invention;

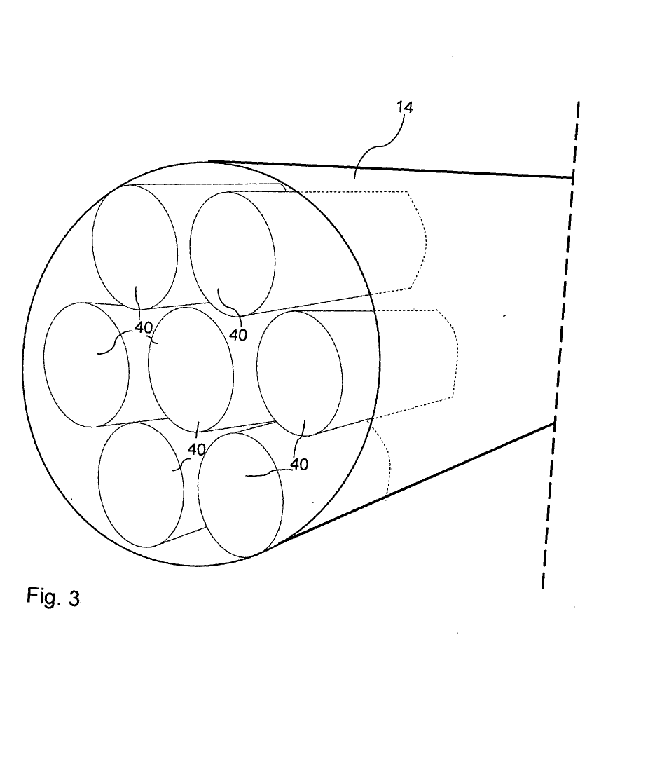

FIG. 3 shows a schematic view of the end of the jet engine according to an embodiment.

FIG. 1 shows a schematic cross section of a jet engine 1 according to an embodiment of the invention. The jet engine 1 comprises an air inlet 2 capable of receiving air, see arrow 20. At the air inlet 2, a fan 3 is arranged which is rotatable and connected to an axis 21. Downstream the fan 3 is a core engine 4 for generating a thrust in a way as is known by the skilled person. The core engine comprises a compressor section 5 arranged to compress the air received from the air inlet 2, and a combustion section 6 arranged to combust fuel and the compressed air, to generate hot, compressed gases. Furthermore, the engine 4, also called core engine 4, comprises a turbine section 5 where the combusted gases drive a turbine 7. The turbine 7 is arranged to rotate the axis 21. At a core engine outlet 8, the combustion gases leave the core engine 4.

The jet engine comprises at least one bypass duct 9 where through air is bypassed with regard to the core engine 4. The bypass duct 9 has a bypass inlet 10 and a bypass outlet 11, see FIG. 1. In this way part of the air passing the outer end parts of the blades of the fan 3 is bypassing the core engine 4 via the bypass duct 9. The bypass duct 9 can be arranged so as to fully surround the core engine 4, but alternatively, the duct can be embodied by one or more air ducts at the outer surface of the core engine 4. As can be seen from FIG. 1, a convergent-divergent nozzle 12 is surrounding at least the rear part of the core engine 4. The nozzle 12 comprises a throat 13 at the minimum cross-sectional area of the nozzle. These parts can be seen as parts of a venturi. The exhaust gases from the core engine 4 and the air from the bypass duct 9 are ejected into the throat 13. The throat 13 is positioned at a site where the combustion gases that leave the core engine 4, and bypass air that leaves the bypass duct 9, initially meet when the engine 1 is operational. In the embodiment of FIG. 1, the outlet 8 of the core engine 4 and the outlet 11 of the bypass duct 9 are both defined by an outer edge 23 of the outlet 11. This outer edge 23 is preferably positioned between 10-70 cm upstream the minimum cross-sectional area of the nozzle 12.

In the embodiment of FIG. 1, the engine 1 comprises a substantially tubular body 25, part of which is forming the bypass duct 9 and another part is forming the nozzle 12. A part of nozzle 12; bypass 11 and the outlet of core engine 8 and throat 13 form a venturi 35, which create, cooperating with diverging exhaust part 14 an under pressure at the outlet 11 of the bypass duct 9 relative to the air pressure in front of the fan 3. This under pressure will create an air flow which will contribute to the rotation of the fan 3. This means that the fan 3 receives rotating energy from the air flowing through the bypass duct 9. Please note that this is contrary to the state of the art turbofan bypass jet engines do in which the fan presses a flow through the bypass duct.

Because of this contribution mentioned, the turbine 7 needs less energy to create the same rotational speed for the compressor 5 and eventual other energy users but not fully for fan 3 like formerly and nowadays is the case. This means that the turbine 7 does not have to extract so much energy out of the combustion gases as it did in the state of the art engines. And therefore more energy is still available for the creation of thrust. This will result in increase of thrust and speed, or it will result in a reduction of fuel when creating the same thrust as before with a smaller core engine now expanded by the improvements we suggest. The gain of thrust is achieved by applying a less powerful turbine in the rear 7 of the core turbojet engine 4 so that a larger part of the energy contents of the hot gases is available for generating thrust. The propelling fan 3 completes the delivery of rotating energy to the central shaft 21 of the core engine.

In an embodiment, the turbine 7 will have fewer blades as compared to the state of the art turbines. This will create a reduction in the resistance met by the combustion gases.

In another embodiment, shown in FIG. 2, part of the combustion gases bypasses the turbine 7. The core gas generator in FIG. 2 comprises the same parts as shown in FIG. 1, but an additional bypass is added 31 with valves 32 in it. In this way an adjustable part of the hot gases can be conducted around the turbine 7 in the rear of the core engine 4 adjustable to different running circumstances such as start, climb, cruise full and tempered power, outside pressure etcetera. The gases bypassing the turbine 7 can be fully used to create the increased thrust of the core gas generator 4. In this alternative embodiment a turbine is installed in the rear of the core engine 7, that can deliver the maximum desired amount of rotating energy to the central shaft 21 and which can be limited by an additional bypass lead 31 that can be adjusted between open and closed 32. The advantage of this solution is that in a simple way the limitation can be arranged by valves according to the need of the moment for regulating the number of turns of the central shaft.

In both the embodiments of FIG. 1 and FIG. 2 a larger part of the energy out of the mainstream of the speedy and hot gases from the core engine is available for generating the original thrust plus the newly available additional thrust.

In an embodiment, the jet engine 1 and the turbine 7 is configured to let the fan 3 rotate at speeds of between 3000-4000 tpm. It is noted that the blades of the fan 3 can be positioned in an optimal way so as to create the wanted rotation speed.

The convergent-divergent nozzle 12 comprises a divergent exhaust part 14 that makes an angle α with a main axis 21 of the jet engine 1, for which counts 10°<α<25°. The precise value can be defined, when the characteristics and the size of the core engine and further construction are known. These values of the divergence of the exhaust part have shown good results during prototyping. Due to the continuously diverging exhaust part 14, the speed of the mixture of air and the exhaust gases will decrease which results in an increase of gas pressure (Bernouilly) until the outside is reached. There atmospherical pressure is taken over and low pressure is built up downstream the throat of the nozzle 13 and available around and in the throat of the said venturi. Besides building up a powerful low pressure source, lowering the exhaust speed will significantly reduce noise levels which is favourable for the environment.

In an embodiment, a diameter of the throat 13, see FIG. 1, can be around two times a diameter of said outlet 8 of the core engine. The final proposition is up to the 2 o design engineer. Due to this narrow throat, the under pressure is optimum for creating the flow through the bypass duct 9. Preferably, a ratio of the diameter of the throat relative to the diameter of said outlet 8 of the core engine is between 1.5 and 3.

Because of the relatively low speed of the final exhaust gases especially in low power duty circumstances a new problem rises and may threat our way to build up more under pressure in the diverging duct. When the pattern of the gas flow is turbulent, streams of gases move in many different directions and guide outside atmospheric air that is seeking the low pressure area in the diverging duct and disturb the process. To prevent this turbulent streaming pattern a number of blades or short pipes may be introduced in the final exhaust opening that will lead the gases straight to the outside. A possible solution for this is shown in FIG. 3 where outlets of the short pipes are indicated with reference numbers 40.

It is emphasized that the present invention can be varied in many ways, of which the alternative embodiments as presented are just a few examples. These different embodiments are hence non-limiting examples. The scope of the present invention, however, is only limited by the subsequently following claims.

1-8. (canceled)

9. A jet engine for an airplane comprising:
an air inlet configured for receiving air;
a fan located adjacent said air inlet, through which the entire amount of the air received from said air inlet passes;
a core engine configured to generate a thrust, said core engine being located downstream from said fan and comprising:
a compressor section configured to compress a first portion of the air received from a central part of said air inlet;
a combustion section configured to combust fuel and the compressed the first portion of the air, and to generate combusted hot gases;
a turbine configured to be driven by the combusted hot gases, said turbine being connected to said fan via a rotation axis; and
a core engine outlet, where the combusted hot gases leave said core engine;
at least one bypass duct through which a second portion of the air received from said air inlet is bypassed with regard to and outside of said core engine to define bypassed air, said bypass duct having a bypass inlet directly downstream of an outer part of said fan and a bypass outlet where the bypassed air leaves said bypass duct; and
a venturi comprising a nozzle, said nozzle having a throat at a minimum cross sectional area of said nozzle, wherein said nozzle is configured to use the combusted hot gases from said core engine to suck the bypassed air through said bypass duct to create a mixed stream, so that the mixed stream is ejected into said throat of said venturi when said core engine is operational;
wherein in said throat is positioned downstream a site where the combusted hot gases that leave said core engine, and the bypassed air that leaves said bypass duct, initially meet to create the mixed stream, when said core engine is operational;
wherein downstream of said throat of said nozzle a divergent exhaust part is arranged, said divergent exhaust part being configured to lead the mixed stream to an outside of said jet engine, and wherein an inner wall of said divergent exhaust part makes an angle with said rotation axis of said core engine that has a value between 10 and 25 degrees.

10. The jet engine according to claim 9, wherein said throat is positioned between 10-70 cm downstream said site where the combusted hot gases that leave said core engine, and the bypassed air that leaves said bypass duct, initially meet.

11. The jet engine according to claim 9, wherein said venturi and said diverging exhaust part of said nozzle are configured to cause an under pressure of the mixed stream in said bypass duct relative to a surrounding air in front of said fan, the under pressure is configured to assist said fan in rotation.

12. The jet engine according to claim 9, wherein a ratio of a diameter of said throat relative to a diameter of said core engine outlet is between 1.5 and 3.

13. The jet engine according to claim 9, wherein said diverging exhaust part comprises a number of blades or pipes configured to cause a straight flow to the outside so as to prevent outside air seeking a low pressure zone created by said nozzle and possibly enter said diverging exhaust part making use of turbulence of the mixed stream that exit said diverging exhaust part.

14. The jet engine according to claim 9, wherein said fan is a tandem fan comprising a first set of blades in an inner part of said fan, and a second set of blades in an outer part of said fan, said blades of said first set having a different pitch from said blades of said second set.

15. The jet engine according to claim 9, further comprising at least one additional bypass including at least one valve, said valve is configured to adjust a portion of the hot combusted gases around said turbine.

16. The jet engine according to claim 9, wherein said bypass duct is formed by a tubular body configured to receive said core engine therein to define a space between said core engine and said tubular body.

17. A jet engine for an airplane comprising:
an air inlet configured for receiving air;
a fan located adjacent said air inlet, through which the entire amount of the air received from said air inlet passes;
a core engine configured to generate a thrust, said core engine being located downstream from said fan and comprising:
a compressor section configured to compress a first portion of the air received from a central part of said air inlet;
a combustion section configured to combust fuel and the compressed the first portion of the air, and to generate combusted hot gases;
a turbine configured to be driven by the combusted hot gases, said turbine being connected to said fan via a rotation axis; and
a core engine outlet, where the combusted hot gases leave said core engine;
a tubular body configured to receive said core engine therein so as to define at least one bypass duct between said core engine and said tubular body, said bypass duct through being configured to receive a second portion of the air received from said air inlet and bypass the second portion of the air with regard to and outside of said core engine to define bypassed air, said bypass duct having a bypass inlet directly downstream of an outer part of said fan and a bypass outlet where the bypassed air leaves said bypass duct; and
a venturi comprising a nozzle, said nozzle having a throat at a minimum cross sectional area of said nozzle, and a divergent exhaust part downstream of said through, wherein said nozzle is configured to use the combusted hot gases from said core engine to suck the bypassed air through said bypass duct to create a mixed stream, so that the mixed stream is ejected into said throat of said venturi when said core engine is operational;
wherein in said throat is positioned downstream a site where the combusted hot gases that leave said core engine, and the bypassed air that leaves said bypass duct, initially meet to create the mixed stream, when said core engine is operational;
wherein said divergent exhaust part being configured to lead the mixed stream to an outside of said jet engine;
wherein a ratio of a diameter of said throat relative to a diameter of said core engine outlet is between 1.5 and 3

18. The jet engine according to claim 17, wherein said divergent exhaust part has an inner wall that makes an angle with said rotation axis of said core engine that has a value between 10 and 25 degrees.

19. The jet engine according to claim 17, wherein said throat is positioned between 10-70 cm downstream said site where the combusted hot gases that leave said core engine, and the bypassed air that leaves said bypass duct, initially meet.

20. The jet engine according to claim 17, wherein said venturi and said diverging exhaust part of said nozzle are configured to cause an under pressure of the mixed stream in said bypass duct relative to a surrounding air in front of said fan, the under pressure is configured to take over a delivery of a substantial part of a necessary rotating energy to a central shaft associated with said rotation axis.

21. The jet engine according to claim 17, wherein said diverging exhaust part comprises a number of blades or pipes configured to cause a straight flow to the outside so as to prevent outside air seeking a low pressure zone created by said nozzle and possibly enter said diverging exhaust part making use of turbulence of the mixed stream that exit said diverging exhaust part.

22. The jet engine according to claim 17, wherein said fan is a tandem fan comprising a first set of blades in an inner part of said fan, and a second set of blades in an outer part of said fan, said blades of said first set having a different pitch from said blades of said second set.

23. The jet engine according to claim 17, further comprising at least one additional bypasses including at least one valve, said valve is configured to adjust a portion of the hot combusted gases around said turbine adjacent a rear of said core engine.
